(19) United States
(12) Patent Application Publication
(10) Pub. No.: US 2004/0002880 A1
(43) Pub. Date: Jan. 1, 2004

(54) Method and system for states of beings configuration management

(76) Inventor: William B. Jones, Fairfax, VA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/228,921

(22) Filed: Aug. 28, 2002

Related U.S. Application Data
(63) Continuation of application No. 09/666,330, filed on Sep. 21, 2000, now abandoned.

(51) Int. Cl. G06F 17/60

(52) U.S. Cl. 705/7

(57) ABSTRACT

The present invention is related to a method, system, and business process for configuration management of an item such as a network. A deployed state of being and a designed state of being for the item are identified. Configuration items in the states of being affected by the change request are identified. The incorporation of a requested change to the states of being is managed using a configuration management application. A pending state of being for the item is generated reflecting the requested change that identifies the configuration items in the states of being having at least one attribute of a configuration item affected by the change. Graphical models, displayable on a display, are generated of all three states of being allowing access to configuration item information, the status of the change, and approval/disapproval of the change.

This application claims the benefit of U.S. patent application Ser. No. 09/666,330, filed Sep. 21, 2000, the contents of which is expressly incorporated by reference herein in its entirety.

### BACKGROUND

1. Field of the Invention

This invention relates to a configuration management process, and more specifically to a configuration management process emphasizing graphical interpretations of states of beings.

2. Discussion of the Related Art

Today, change is always occurring. This is especially true in the manufacturing and technology areas. Products being manufactured are many times replaced with newer models that have been modified in some way from the original product. In technology, software is consistently modified and revised to be better, as well as hardware being designed to either run faster, have more capability, run at less power, etc. Systems and networks also experience change, when a new device or new network node is added, or if a change in function or service provided is added or deleted. Problems occur when the impact of these changes are not fully comprehended by every organizational entity the change effects.

A simple change to an item configuration, etc., affects many other items related to the changed item. For example it may be desired to modify or change an automobile that currently exists n the market. Although the change may be simple this may include adding or deleting parts, a changed or modified manufacturing process, and upgrading the documentation due to the change. These are just a few of many possible areas that the change to the car may affect. Many times, although the change is made, only some of the other areas affected are modified to reflect the change. Moreover, the other areas affected may not reflect the change for some time after changes were initially incorporated. This is problematic in that the new car now on the market, although incorporating the change, may not have appropriate documentation that also incorporates the change. Further, areas related to the car such as cost, performance, etc., may have been affected by the change and have new information associated with the new car, but the new information may not be associated with the change that was incorporated into the car. Therefore, in some areas that are affected by the change relating to the car, the history of changes from the previous car to the new car may be missing or incomplete.

Problems such as these are currently prevalent in the area of network configurations. Networks may be consistently experiencing change, for example, adding/modifying/deleting network nodes, adding/modifying/deleting network capability, adding/modifying/deleting network services, etc. With so many changes happening (possibly concurrently and frequently), the ability to monitor and track these changes is desirable and increasingly necessary in order to maintain positive command and control of the deployed network.

A network design results in a cost for a specific Grade or Quality of Service to the subscriber or user community. Once a network is deployed, other stakeholders in the configuration management process may not have access to, or knowledge of, the network design specifications and topology. The culture of the telecommunications industry has always been to respond (react) to the real-time requirements of the customer. Quite often, service is provided first and backend systems are fixed later. More often than not, those fixes never occur because network management issues have a higher priority over configuration management requirements.

Moreover, specifications that describe a network require constant updates and amendments. If documentation engineers are not integrated into the considered configuration management process, they are often placed in a catch-up position. In fact, sometimes it is assumed that most network documentation is always outdated, therefore, why keep it.

Therefore, there is a need for methods and systems that associate several ‘states of beings’ of an entity or item undergoing changes whereby all facets of the change is coordinated for stakeholder command and control.

### SUMMARY

The present invention is related to a method, system, and business process for configuration management of an item such as a network. The present invention allows the user to view and overlay, interrogate, command, and control Designed, Deployed, and Pending states of being of an item on a desktop computer or other computing device capable of generating a graphics display and provide point and click icon interrogation. According to the present invention, all candidate changes to an item's states of beings may occur in the item's designed model. A system according to the present invention may include a collection of knowledge bases, information stores, processes, policies, and computer hardware/software needed to produce design, deployed, and pending views of an item. The present invention allows for access to configuration item information, the status of the change, and approvals/disapprovals of the change. A business process according to the present invention may include an ordered set of tasks network stakeholders perform to ensure institutional memory is preserved and change management culture and policies reflect enforcement of best practices.

### BRIEF DESCRIPTION OF THE DRAWINGS

The present invention is further described in the detailed description which follows in reference to the noted plurality of drawings by way of non-limiting examples of embodiments of the present invention in which the like reference numerals represent similar parts throughout the several views of the drawings and wherein:

FIG. 1 is a block diagram of Configuration Management Methodology functions relating information flows and processes according to an example embodiment of the present invention;

FIG. 2 is a flowchart describing processes for creating and declaring a designed state of being according to an example embodiment of the present invention;

FIG. 3 is a flowchart of a configuration provisioning process that references a declared designed state of being according to an example embodiment of the present invention;

FIG. 4 is a diagram showing an ETACC end-to-end business process according to an example embodiment of the present invention;

FIG. 5 is a diagram of decomposition of Extraction and Translation components of a ETACC business process according to an example embodiment of the present invention;

FIG. 6 is a diagram of a decomposition of association, coordination, and control components of an ETACC business process according to an example embodiment of the present invention;

FIG. 7 is a diagram showing a system architecture for change management according to an example embodiment of the present invention;

FIG. 8 is a diagram of graphical representations of network configurations according to an example embodiment of the present invention;

FIG. 9 is a diagram of example configuration items and their associated attribute tables according to an example embodiment of the present invention;

FIG. 10 is a diagram of an attribute table defining the logistics associated with a configuration item according to an example embodiment of the present invention;

FIG. 11 is an attribute table defining the costs associated with the example configuration item in FIG. 10 according to an example embodiment of the present invention; and

FIG. 12 is a diagram of an example change request approval form according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phase “in one embodiment” in various places in the specification are not necessarily all referring to the same embodiment.

The present invention relates to methods and systems for configuration management of an item's designed, deployed, and pending ‘states of beings’. According to the present invention, changes may be analyzed, validated, and approved at the item's ‘designed state of being’. In addition, these changes may be processed in ordered phases that include the configuration management lifecycle. The present invention may use outputs generated by change management stakeholders, who perform repeatable processes and supply information and data that describe the item's designed state of being. A designed state of being may be used as a reference for approving changes to the provisioning a physical configuration or changing an existing configuration.

To help illustrate the present invention, physical configurations and existing configurations may be referred to as a ‘deployed state of being’. Many organizations may have already developed and deployed configurations that now require change management. In these cases, according to the present invention, the physical configuration description may be used as a baseline (frozen) and Associated States of Beings (etc., Logistics and Finance) incorporated for use as the declarative designed baseline.

In many cases, organizations require development of new configurations to meet evolving mission objectives. According to the present invention, the creation or declaration of a ‘designed state of being’ may be utilized to serve as the approval reference for creating and implementing a ‘deployed state of being’. A graphical representation or model may be created of both the designed and deployed states of being. The user may overlay the designed and deployed views on the same graphics display for visual comparative analysis.

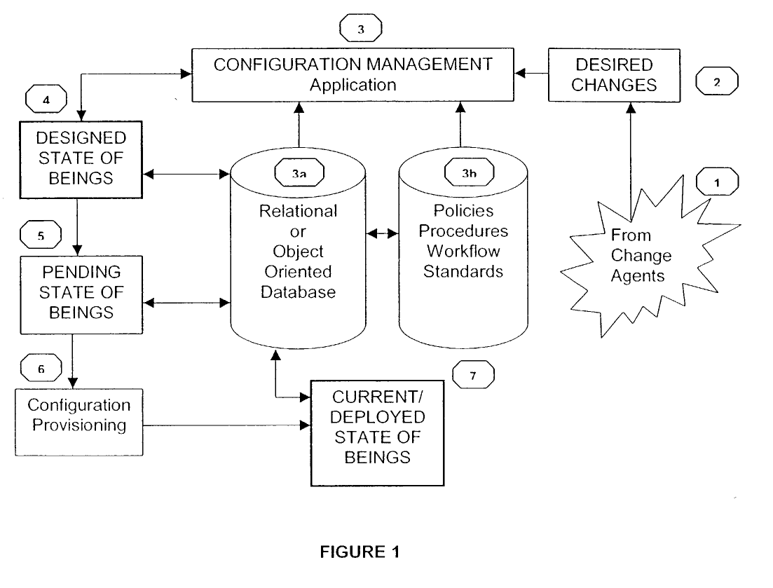

FIG. 1 shows a block diagram of Configuration Management Methodology functions relating information flows and processes according to an example embodiment of the present invention. Change agents 1 (internal and external) may submit candidate change request forms 2 to stakeholders via a configuration management application 3. Commercial Off the Shelf (COTS) software may be used for configuration management application 3 (an integrated process workflow). The configuration management application 3 may serve as the common platform for all change management stakeholders. Each stockholder's work processes may be modeled in a lifecycle and transition interfaces created between stakeholders through delegated roles and responsibilities. Data and table attributes describing designed 4 and deployed 5 (pending) states of beings may be processed in the configuration management application 3 and stored in a relational or object oriented database 3a. An additional table space 3b may provide close association between network item attributes and stakeholder processes. A designed state 4 may be created by the configuration management application 3 and serve as the frame of reference by stakeholders processing the change request. The double arrows indicate interactions between stakeholders and information stores for decision and processing support. The pending state 5 may list all changes approved by stakeholders but are not implemented in the deployed state of being. A configuration provisioning process 6 may be incorporated into the present invention and be the sole activity authorized to implement changes to the deployed state of being 7.

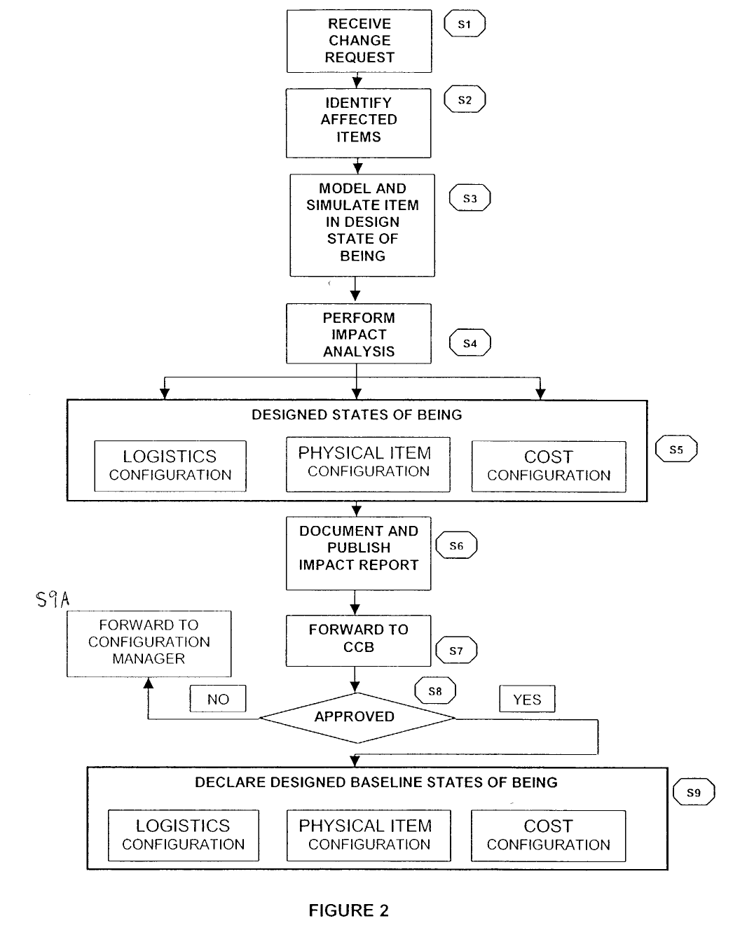

FIG. 2 shows a flowchart describing processes for creating and declaring a designed state of being according to an example embodiment of the present invention. A change request may be received S1. A business process component of identifying affected items may be asserted as the point of stakeholder integration S2. Business or operational personnel who have a mission interest in the impact of suggested changes may be integrated into the change lifecycle with varying levels of roles and responsibilities. These roles and responsibilities may be determined by creation of a change management policy and procedures. According to the present invention, these policies and procedures may be enforced through the creation of forms, data stores, procedural workflow processes, and an automated data processing system. The present invention leverages the best practices for modeling and simulating configuration changes. The item in the design state of being may be modeled and simulated S3. According to the present invention, a single assessment platform may be provided where stakeholders can be assess all aspects (associated states of beings) of the impact of implementing the change in the design state before committing to changing the deployed configuration S4, S5. An impact report may be documented and published S6. The impact report may be forwarded to a Configuration Control Board S7 for approval. It is determined if the changes are approved S8. If approved, the changes to the designed state of being may be documented and this state declared as the reference authority S9 for the configuration provisioning process. If not approved, the changes may be forwarded to a configuration manager S9A.

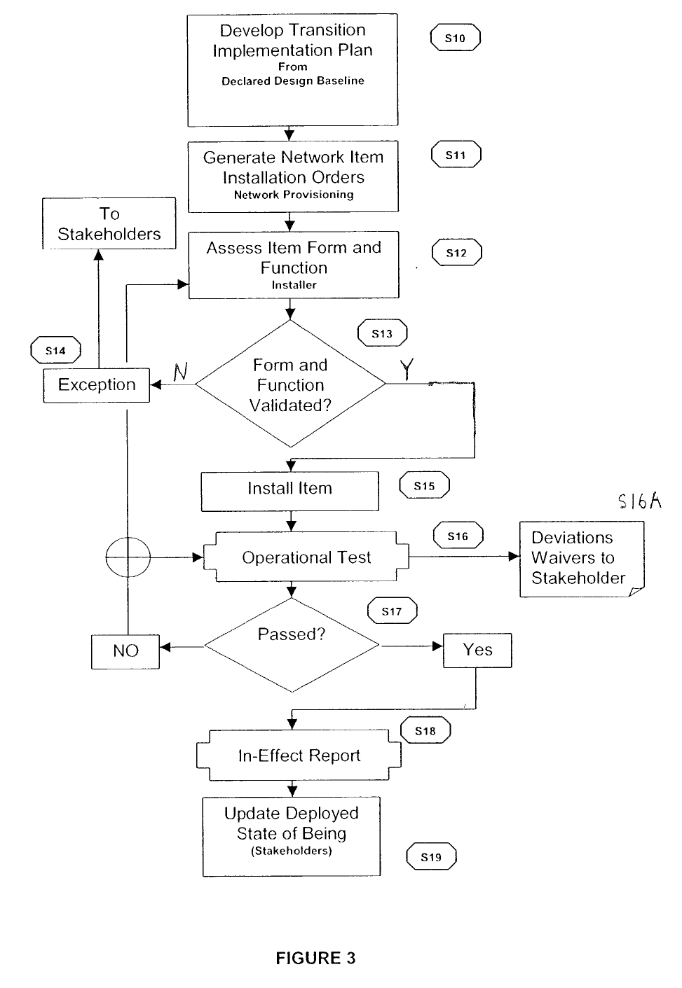

FIG. 3 shows a flowchart of a configuration provisioning process that references a declared designed state of being according to an example embodiment of the present invention. According to the invention, configuration provisioning may be ‘passive directed’ which places the burden and responsibility of analysis, validation, and approval in the design domain. Configuration provisioning may occur in the pending domain with interaction with the design domain only when an item's form and function cannot be satisfied in the deployed domain. The passive directed approach for change management is possible due to sophistication and precision now possible in current statistical based modeling and simulation tools. These tools with refined predictive logic and reliance on empirical knowledge bases can produce behavioral models with a high degree of accuracy and small margins of error. According to the present invention, these modeling and simulation technology advancements may be leveraged by shifting configuration control to the design (modeling and simulation) domain. Therefore, configuration provisioning becomes a mechanical process that can reduce the time for implementation by using economic market place drivers as incentives for rapid deployment.

A Transition Implementation Plan may be created S10 for large or wholesale changes to a deployed configuration. The plan may provide a schedule for implementing configuration changes identified in the declared design state of being. Some changes, while significantly impacting the deployed state of being, may not require the need for a Transition Implementation Plan. According to the present invention, the system may generate an Item Installation Order form, with an affixed tracking and control number S11. The item form and function may be assessed S12. It is determined whether the form and function is validated S13. If not validated, stakeholder involvement may be provided for throughout the change lifecycle since the form and function of the change deviates from the simulated impact performed, measured, and/or calculated in the designed state of being S14. If validated, the item may be installed S15.

Circumstances may arise where the item's form and function satisfy threshold requirements but the implementation process fails due to relational dependencies of the installation activity. Installers may lack the requisite inventory or personnel. These occasions where the installation does not proceed may not be the fault of poor design or planning by the configuration management authority. However, according to methods and systems according to the present invention, these possibilities may be foreseen by establishing a communications feedback process (Operational Test) S16 to the configuration management authority. A business process according to the present invention may require the installing agent to issue delayed provisioning reports, deviations, and waivers S16A when applicable.

It may be determined whether the installed item operational test has passed S17, and if so, successful installations may be reported to the configuration management authority by issuance of an in-effect report S18. The in-effect report, besides signaling that the change has occurred to the deployed configuration, may contain aggregate cost information used for updating the financial and logistical states of beings, when applicable S19. If the installed item operational test has not passed, this may be considered an exception S14 and reported to stakeholders and/or the operational test repeated S16.

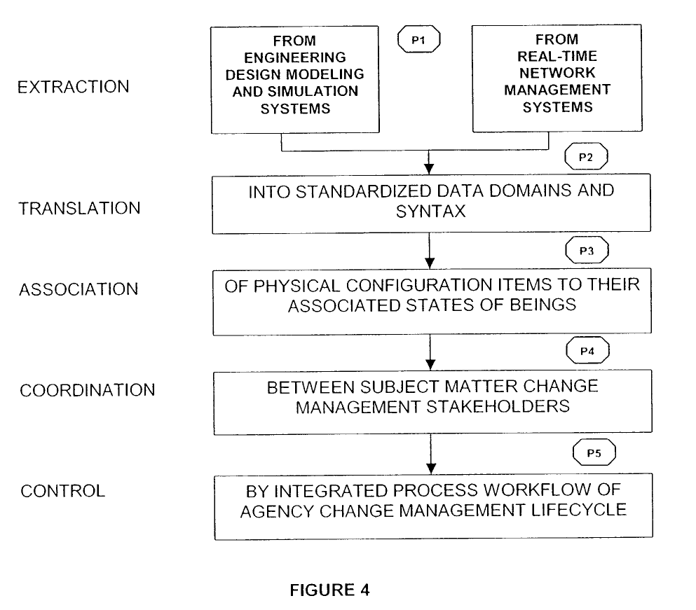

FIG. 4 shows a diagram showing an ETACC end-to-end business process according to an example embodiment of the present invention. Components of an ETACC (Extraction Translation Association Coordination and Control) business process have been mentioned in the context of describing the configuration management methodology and methods used to declare and leverage a designed state of being. The Extraction process P1 may utilize commercial and technical best practices for importing data tables and attributes from legacy databases into another data repository. Commercial and technical best practices may include standard query and database language libraries, application program interfaces, and data link libraries. The purpose of employing these extraction techniques is to share existing data that describes designed and deployed configurations from design and operational systems, respectively. The Translation process P2 compares exported data to a reference standard such as a data dictionary. Variations are modified in accordance to usage rules and syntax established by configuration management policy. The Translation process P2 may convert external imported data and write this data to a configuration management application database.

The Association process P3 relates configuration data and metadata to change management stakeholder roles and responsibilities. An additional association occurs by relating organizational best practices and core competencies to each change management stakeholder. By associating configuration item data, stakeholders, and organizational core competencies, the present invention embodies a cohesive change management environment that enables performance measurements and accountability.

According to the present invention, a common Automated Data Processing (ADP) system and client/server architecture may be used to effect the coordination P4 between change management stakeholders. Control of changes may be accomplished by creating a computer based Configuration Control Board leveraging technology that allows for interactive communications and digital signatures. Preferably, configuration management policies allow for approval of changes presented in electronic forms using a pointing device such as a computer mouse. A structured integrated workflow process streamlined to compress workloads further defines the control activity P5. This structured integrated workflow also supports performance accountability and stakeholder adherence to best practices and the organization's core competencies.

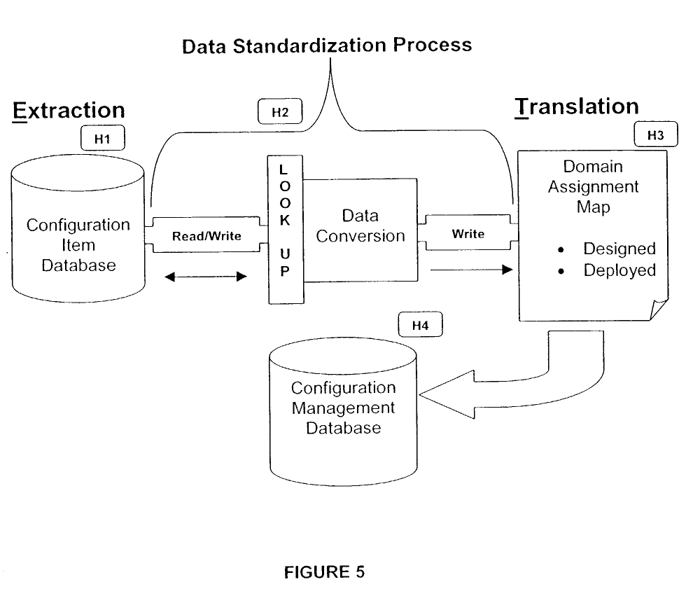

FIG. 5 shows a diagram of decomposition of Extraction and Translation components of a ETACC business process according to an example embodiment of the present invention. Extraction and Translation may be repeatable processes for the general application of importing configuration data item attributes for use in the configuration management methodology. A configuration item database H1 may contain legacy data items describing designed and deployed states of beings. In order to effect data reuse and leverage existing technology investments, the present invention imports data from configuration item databases to a temporary storage space. Data standardization processes H2 may convert imported data to data attributes defined by a data dictionary. The converted imported data may be first stored in a second storage space and finally indexed to the respective domain consistent with its legacy data source. The difference between imported data from extraction H1 to converted data in translation H3 is the standardization legacy data undergoes to adhere to data dictionary standards. This process of translation may be achieved by using a domain assignment map. The standardized and properly mapped data may be written to a configuration management database H4. The configuration management database H4 may contain both configuration items and procedures for configuration management. Configuration management software may reside on a server device that is connected to configuration management database H4.

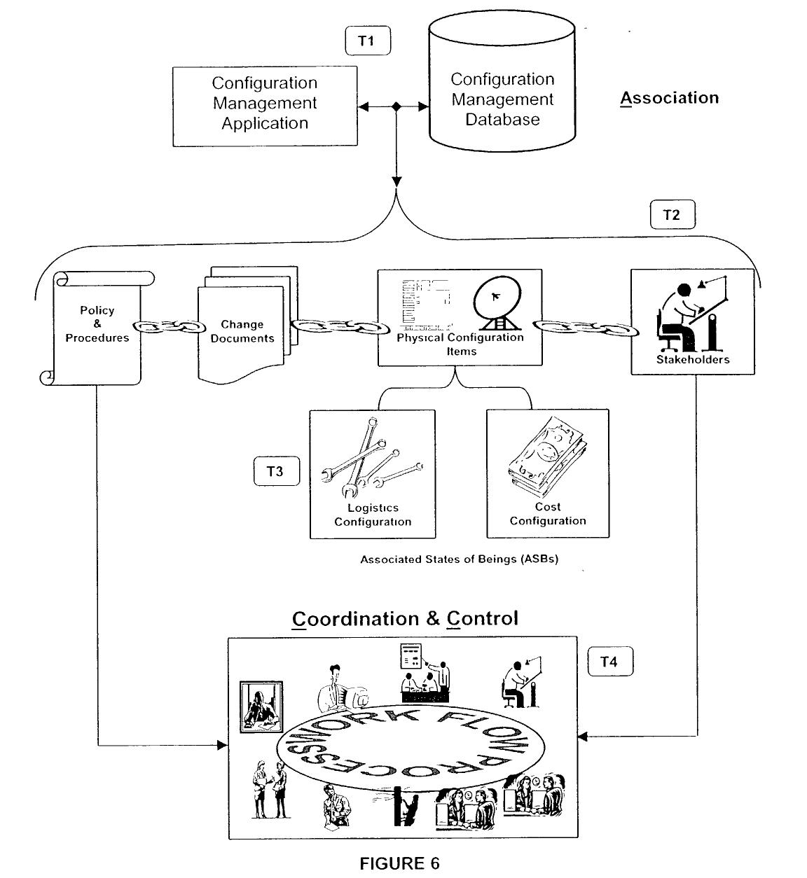

FIG. 6 shows a diagram of a decomposition of association, coordination, and control components of an ETACC business process according to an example embodiment of the present invention. A configuration management application and database (T1) are components that complete the association of change management stakeholders, configuration items, and agency core competencies. Core competencies may be defined in the configuration management application and be assigned to each stakeholder in accordance to their specific roles and responsibilities T2 (e.g., policy and procedures, changes documents, physical configuration items, stakeholders, etc.). Further association T3 may occur between physical configuration items and associated states of beings (e.g., logistics, finance, etc.). Coordination between stakeholders and control of change management polices may be controlled via a common system platform T4. Integrated process workflow, modeled by the configuration management application, reinforces control and stakeholder communications.

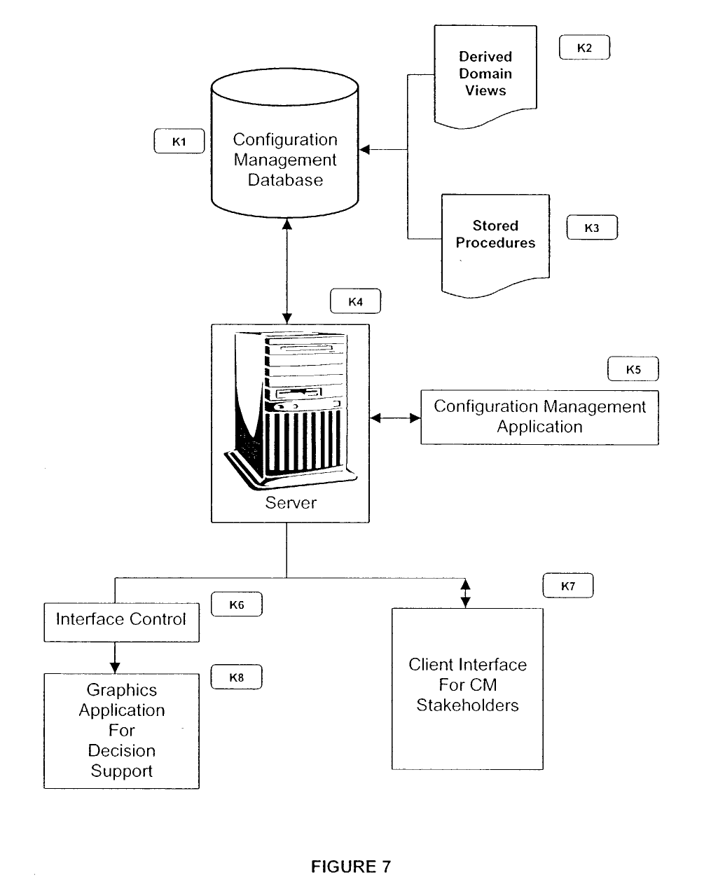

FIG. 7 is a diagram showing a system architecture for change management according to an example embodiment of the present invention. Currently, a proliferation of databases and database management systems exist through government and enterprises. Technology advancements and trends are major reasons why data repositories may not be effective to share information and data. Due to standardization and coordination processes according to the present invention, a common data repository may be relied upon that contains relations (indexes) between data and processes. The missions and responsibilities of stakeholders vary but coordination may be enhanced by access to a common configuration management database.

A configuration management database K1 supports Database Definition Languages (DBDLs) that permit the creation of virtual tables or derived domain views K2. Domain views, as shown in FIG. 7, refer to specific aspects of the configuration a stakeholder is responsible for maintaining. According to the present invention, DBDLs and other commercially available software may be used to enable generation of stakeholder views K2. The configuration management database K1 may also contain stored procedures K3 that may be repeatable processes, which define agency core competencies for change management. Configuration management software provides the utilities used to generate domain views and document agency procedures. Together, domain views, base configuration data, and store procedures define the configuration management database.

A server K4 may provide coordination and control of all configuration management activity. The server may provide access to stored procedures and domain views needed by change management stakeholders The server may host a configuration management application K5 which enables enforcement of procedures, stakeholder access to common information, workflow processing, and creation of forms to include automated configuration review and approval forms processing. An Interface Control device K6 may be used to enable stakeholders to use commercially available graphics software K7 without changing Open Database Connectivity (ODBC) specifications assigned to the server. A separate stakeholder client interface may be needed for an application-specific configuration management system. Although comparative analysis of the designed, deployed, and pending states of being may be viewed with a commercially available graphical user interface, a different application-specific interface K8 for stakeholders may be desired. This flexibility also allows for varying degrees of access to the change management process. The applications residing on the server and/or client devices may be general in nature in that the application and configuration management process may be portable to other dissimilar items experiencing change, or the applications may be customized to a specific item, software product, network, etc. to perform the configuration management process. An example of a configuration management application K5 that may be used to implement the present invention includes Product Version Change System (PVCS) Dimensions®. PVCS Dimensions is a commercial off-the-shelf (COTS) product that allows for comprehensive process control, workflow management, version management, issue management, build management, baseline management, and release management. The present invention is not limited to the use of this product as other configuration management applications may also be used in the implementation of the present invention.

Moreover, Geographical Information System (GIS) may be used to implement the development and presentation of three-dimensional graphical representations (views) of designed, deployed, and pending states of beings. An example GIS application that may be used to implement the present invention's graphical capability includes Environmental Systems Research Innovation (ESRI) ArchView®. ArcView is a COTS product that allows graphical presentation of an item's configuration and/or attributes on a computer screen and provides for a fully open integration to other systems.

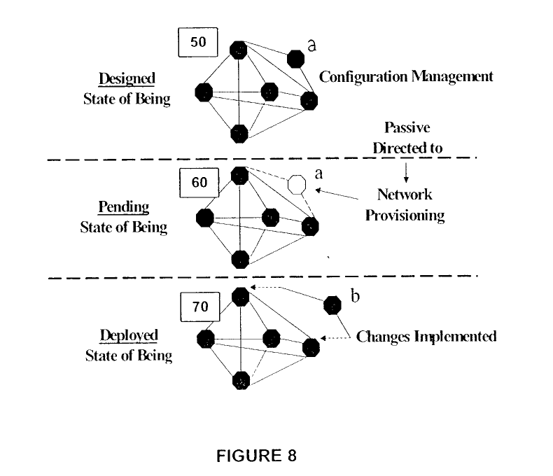

FIG. 8 shows a diagram of graphical representations of network configurations according to an example embodiment of the present invention. Network configuration model 50 represents the designed network. Since this network does not exist in a physical state, its existence is referred to as being in a ‘designed state’, hence, a designed state of being. Network configuration 60 represents a pending network. Since this network does not exist in a physical state, its existence is referred to as being in a pending state, hence, a pending state of being. In each model, circles and lines represent switching systems and transmission media, respectively. According to this example embodiment of the present invention, network planners envisioned six switching systems and inter connecting media. The costs, logistics, personnel resources, and accompanying documentation represent the anticipated grade of service to the subscribing community. The present invention allows decision support users and stakeholders an official reference for managing the network configuration. The present invention allows the ability to view costs and logistics support states of beings that are associated with the designed network.

Network model 60 depicts actions taken to align the designed state 50 to the deployed state 70. The present invention allows a user to quickly identify the difference between design and deployed states. In this embodiment, the design state 50 has an additional switch (a) not included in the deployed state 70. The pending network model 60 shows the user pending changes (a) to the network. Eventually, pending changes (b), processed by the network provisioning activity are reflected in the deployed network model 70. In this example embodiment of network configurations, configuration items may represent network components such as switches, routers, echo cancellers, trunks, and user end instruments. Each configuration item may have one or more associated attribute.

The three-dimensional network model shown in FIG. 8 may be displayed on a computer screen to allow decision support users and change management stakeholder instant analysis of the network states of beings. The present invention allows the user to interrogate each configuration item displayed on the screen and view table attributes for additional information. Moreover, a configuration management process according to the present invention allows users to enter a requested change, track pending changes, and approve or disapprove changes on computer-generated forms. Each configuration item in the pending state of being may be indexed to the appropriate change management form at the table and attribute level. This is advantageous from the user's perspective because configuration management may be enabled by using point and click devices (mouse) to eliminate unnecessary paper and written signature approvals.

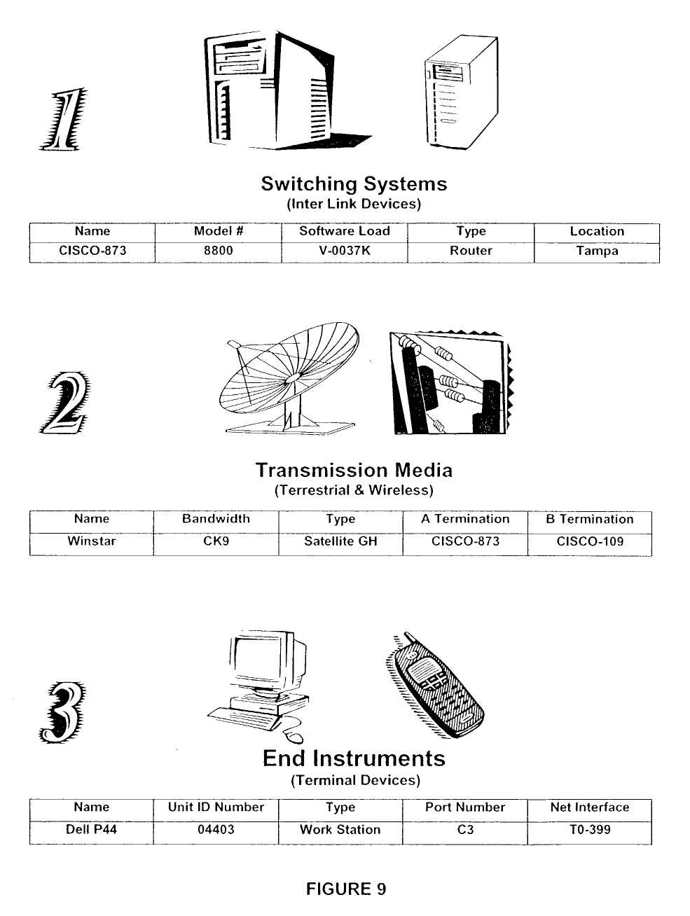

FIG. 9 shows a diagram of example configuration items and their associated attribute tables according to an example embodiment of the present invention. FIG. 9 shows the three configuration items that define most telecommunications networks. Section 1 of FIG. 9 shows network switching systems such as a router or voice switch. These items may be sub captioned as ‘Inter Link Devices’ because they connect various transmission links together to enable a communications path. Other link devices may impede, attenuate, or amplify signals traversing the communications path. A sample attribute table is listed below the switch items to depict their example representation in a database. Communications paths are indicated in Section 2 of FIG. 9 along with an example attribute table. Section 3 of FIG. 9 shows a list of terminal/terminating devices and an example attribute table.

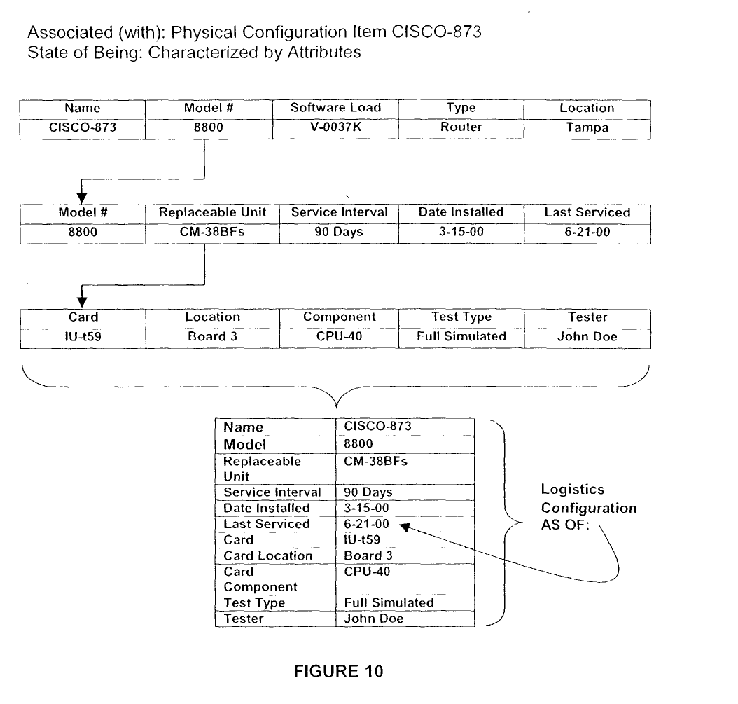

FIG. 10 shows a diagram of an attribute table defining the logistics associated with a configuration item according to an example embodiment of the present invention. In this example embodiment, the configuration item is a CISCO router. This attribute table exists for each specific configuration and may have a description of the configuration item as a heading or label of the table. The table may consist of one or more attributes where each attribute may have specific details associated with it (e.g., Cisco-873→model 8800→replaceable unit CM-38BFs→card IU-t59, etc.).

A configuration item table such as this may include all attributes associated with the specific configuration, or may only contain those attributes that are effected by a change request. A configuration item table including its attributes may be modeled in a relational or object oriented format and stored in a database. The present invention allows decision support personnel the ability to associate the impact of logistics to a configuration item. Often logistical considerations and information pertinent to configuration logistics are not tightly associated with the change management process. Separate information systems contain logistics data and may not be updated to reveal the cost and personnel impact changes may impose on budget and other administrative requirements. The present invention allows users to construct information pertinent to logistics planning and forecasting from logistics attributes associated with configuration items attributes in the database.

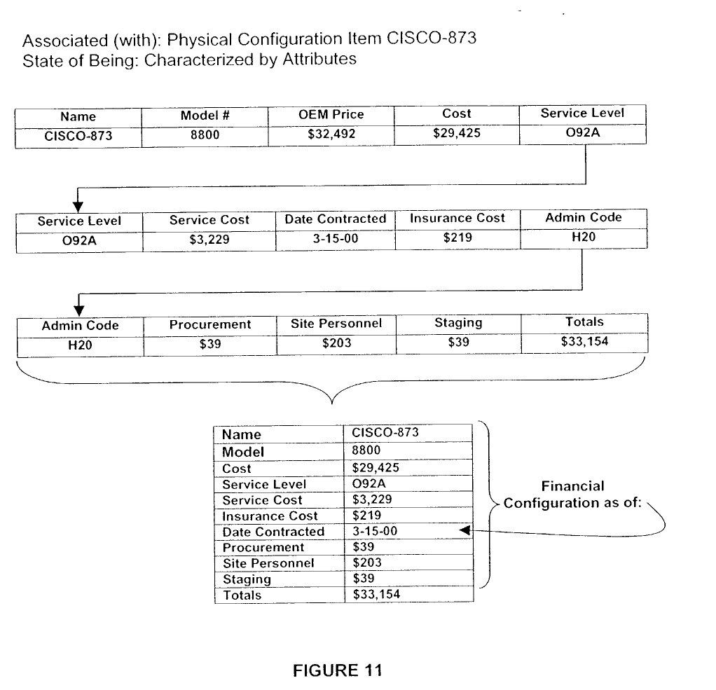

FIG. 11 shows an attribute table defining the costs associated with the example configuration item in FIG. 10 according to an example embodiment of the present invention. Attributes describe several cost elements such as item, service level, insurance, and administration. The present invention utilizes the same rationale for declaring these costs as associated to the CISCO router configuration item. The contracting date snap shots a fixed state of being for assessing the impact of cost when considering a configuration item change. Thus, a financial state of being may exist whenever configuration item changes are contemplated. The present invention may associate and imbed cost elements within the configuration item to create a financial state of being. As new configuration items are improved so does the configuration of cost elements, which, in turn, impact organization budgets and financial commitments.

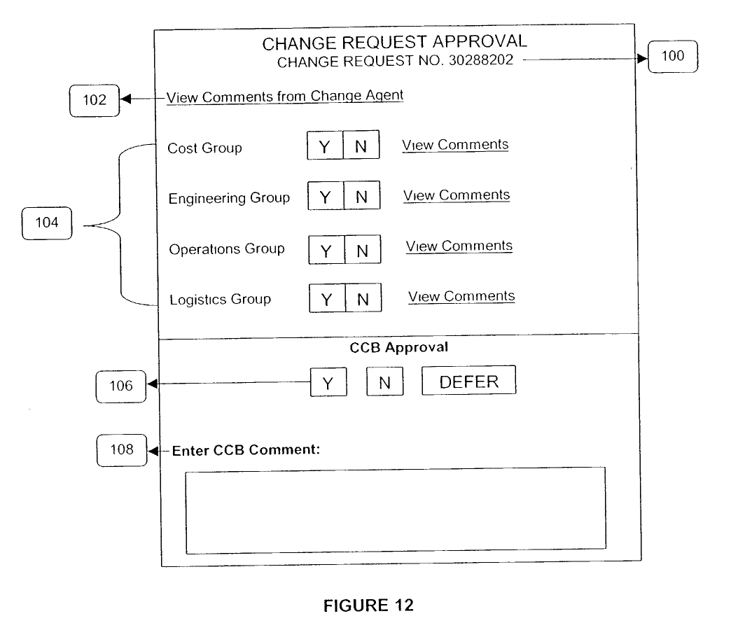

FIG. 12 shows a diagram of an example change request approval form according to an example embodiment of the present invention. According to the present invention, stakeholders and a Configuration Control Board (CCB) may use this form. This form may be displayed as part of a graphical user interface generated by a configuration management application. The form may include the change request tracking number 100, or may have an entry area where a user may enter a change request number that retrieves legacy reviews and disposition of information of pending requests. A view comments area 102 permits decision support users to read the comments originating from the change agent responsible for submitting the change request. The key stakeholders 104 may provide approval/disapproval using a pointing device such as a mouse. Each stakeholder can provide comments explaining their rationale for approval or disapproval. The present invention allows for quick review and justification for actions taken without the need to convene meetings where travel and other logistical constraints may impose undue burdens to change control stakeholders. The form may also contain a section for the Configuration Control Board approval 106. CCB members may select “Yes” to approve the change, “No” to disapprove the change, or “Defer” to defer a decision to a later date. The CCB may also have the ability to enter comments that explain the decision 108 for change request approval. The present invention allows organizations the flexibility to have multiple members of the CCB and each member has the same stakeholder information 104 for additional decision support. Although specific information has been shown here in this example form, other information may also be included or some of this information omitted and still be within the spirit and scope of the present invention.

The present invention is advantageous in that designed, deployed, and pending views of a configuration may be displayable on one screen. Moreover, methods and systems according to the present invention integrate but preserve workflow processes of each configuration management and network provisioning stakeholder. Further, document development and management processes may be automated by embedding ‘item substitution variables’ into textual portions of documents. These item variables may be indexed to configuration item attributes in the change management application. In addition, the auditing of deployed assets and changes made to network elements may be automated. User directed snap shots of a deployed, pending, and designed baseline may be provided. Moreover, the Configuration Control Board functions of configuration management may be automated.

Other advantages include the coupling of funding and design to configuration control, the generation of user defined change control documents, the capturing and storing of a user's or corporation's or entity's methods, procedures, change control rules, and configuration items data in a relational or object oriented database, and providing the same look and feel graphical user interface for each user or stakeholder in the configuration management and network provisioning process.

It is noted that the foregoing examples have been provide merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather the present invention extends to all functionally equivalent structures, methods and uses, such as are within the scope of the appended claims.

What is claimed is:

1. A method for configuration management of an item comprising:
receiving a change request for an item;
identifying a deployed state of being for the item;
identifying a designed state of being for the item;
identifying items in at least one of the deployed states of beings (e.g., logistics, finance) and the designed states of being (e.g., logistics, finance) affected by the change request; and managing the incorporation of the requested change using a configuration management application.

2. The method according to claim 1, further comprising generating a pending state of being for the item reflecting the requested change.

3. The method according to claim 1, further comprising identifying items in at least one of the deployed logistics states of beings and the designed logistics states of being affected by the change request; and managing the incorporation of the requested change using a configuration management application.

4. The method according to claim 1, further comprising identifying items in at least one of the deployed finance states of beings and the designed finance states of being affected by the change request; and managing the incorporation of the requested change using a configuration management application.

5. The method according to claim 1, further comprising identifying configuration items in at least one of the deployed state of being and the designed state of being, the configuration items having at least one attribute affected by the change request.

6. The method according to claim 1, further comprising generating graphical models, displayable on a display, of the designed state of being, the deployed state of being, and the pending state of being.

7. The method according to claim 6, further comprising obtaining information regarding configuration items using the graphical models.

8. The method according to claim 6, further comprising tracking a status of the change request using the graphical models.

9. A method for configuration management comprising:
identifying a proposed change to one of a deployed state of being and a designed state of being;
generating three dimensional models for the deployed state of being and the designed state of being;
generating a three dimensional model of a pending state of being, the pending state of being model reflecting the proposed change;
identifying and associating change dependent attributes with the deployed state of being model, the designed state of being model, and the pending state of being model; and
controlling the changing of the attributes, based on the proposed change, of two of the deployed state of being model, the designed state of being model, and the pending state of being model based on the attributes of one of the deployed state of being model, the designed state of being model, and the pending state of being model using a configuration management application,
wherein the models may be displayed, manipulated, and compared on a display.

10. The method according to claim 9, further comprising modeling the attributes as a table using one of a relational and object oriented methodology.

11. The method according to claim 9, further comprising using a configuration management application comprising Product Version Change System (PVCS) Dimensions®.

12. The method according to claim 9, further comprising generating the three dimensional models for the deployed state of being, designed state of being, and the pending state of being using a Geographical Information System (GIS) comprising ArcView®.

13. A system for network configuration management comprising:
at least one server device operatively connected to a network, the at least one server device hosting at least one application supporting a configuration management process; and
at least one client device operatively connected to a network, the at least one client device allowing a user to at least one view, track, approve, disapprove, and comment upon changes to an item undergoing the configuration management process.

14. The system according to claim 13, the client device further comprising a pointing device, the user being able to at least one view, track, approve, disapprove, and comment upon the changes to the item using the pointing device.

15. The system according to claim 13, wherein the item comprises a network.

16. The system according to claim 15, the at least one application providing graphical images of the network on a display at the at least one client device.

17. A method for network configuration management comprising:
receiving at least one change request related to at least one configuration item in at least one of the designed network configuration and the deployed network configuration;
identifying configuration items in a designed network configuration and in a deployed network configuration, each configuration item having at least one attribute;
identifying change dependent attributes for each configuration item; and
managing incorporation of changes to at least one of the designed network and the deployed network using a change control process.

18. The method according to claim 17, further comprising receiving the at least one change request from a change agent.

19. The method according to claim 18, further comprising receiving the at least one change request from an internal change agent, the internal change agent being associated with an enterprise containing at least one of the designed network configuration and the deployed network configuration.

20. The method according to claim 18, further comprising receiving rationale for the change request from the internal change agent.

21. The method according to claim 20, further comprising receiving the at least one change request from an external change agent.

22. The method according to claim 21, further comprising receiving the at least one change request from an external change agent comprising an act of nature.

23. The method according to claim 17, further comprising analyzing at least one of technical information, cost information, and impact information related to the desired network configuration.

24. The method according to claim 17, further comprising identifying configuration items comprising network nodes in the designed network configuration and the deployed network configuration.

25. The method according to claim 24, further comprising identifying network nodes comprising at least one of client devices, server devices, switching devices, routing devices, gateway devices, and storage devices.

26. The method according to claim 25, further comprising comparing the change dependent attributes in the designed network configuration with the change dependent attributes in the deployed network configuration.

27. The method according to claim 17, further comprising selecting the change dependent attributes desired to be tracked based on the change request.

28. The method according to claim 17, further comprising selecting the change dependent attributes desired to be tracked based on at least one of technical information, cost information, and impact information related to the designed network.

29. The method according to claim 17, further comprising representing each configuration item as a table containing its attributes.

30. The method according to claim 17, further comprising representing each configuration item as a table containing its change dependent attributes.

31. The method according to claim 30, further comprising comparing the change dependent attributes of the designed network configuration and the deployed network configuration.

32. The method according to claim 17, further comprising generating a pending network configuration, the pending network configuration identifying changes to the deployed network configuration based on the at least one change request.

33. The method according to claim 32, further comprising using change dependent attributes of the pending network configuration to control the change dependent attributes of the desired network configuration.

34. The method according to claim 32, further comprising the pending network configuration identifying configuration items being at least one of planned, approved, and awaiting implementation.

35. The method according to claim 32, further comprising generating graphical representations of at least one of the desired network configuration, the pending network configuration, and the deployed network configuration.

36. The method according to claim 35, further comprising generating the graphical representations using at least one of Structured Query Language (SQL) and Data Manipulation Language (DML).

37. The method according to claim 35, further comprising overlaying the graphical representation of at least one of the designed network configuration, the pending network configuration, and the deployed network configuration over the graphical representation of at least one of the designed network configuration, the pending network configuration, and the deployed network configuration on a display.

38. The method according to claim 37, further comprising determining the different attributes for configuration items in each graphical representation.

39. The method according to claim 38, further comprising determining at least one of a change history and a rationale for the change for a configuration item from at least one of the graphical representations.

40. The method according to claim 32, further comprising representing at least one of the designed network configuration, the pending network configuration, and the deployed network configuration in a Geographical Information System (GIS).

41. The method according to claim 40, further comprising representing the at least one of the designed network configuration, the pending network configuration, and the deployed network configuration in a Geographical Information system (GIS) that includes ArcView®.

42. The method according to claim 35, further comprising modeling the configuration items in at least one of a relational and an object oriented format.

43. The method according to claim 42, further comprising storing the modeled configuration items in a database.

44. The method according to claim 17, further comprising managing the configuration item changes with a change control process that uses Product Version Change System (PVCS) Dimensions®.

45. The method according to claim 17, wherein the change control process comprises:
validating a rationale for the at least one change request;
deciding on one of approving and disapproving the validation of the at least one change request;
analyzing an impact of the at least one change request if the validation is approved;
deciding on one of approving and disapproving the at least one change request; and
implementing the at least one change request if approved.

46. The method according to claim 45, further comprising deciding the one of approving and disapproving the at least one change request by a Configuration Control Board (CCB).

47. The method according to claim 46, further comprising using a computer mouse device to enter decisions by members of the CCB, the decisions being entered by pointing to an area of a graphical display and clicking a button on the computer mouse device.

48. The method according to claim 47, further comprising reviewing a comment regarding the at least one change request on the graphical display by at least one member of the CCB before entering the decision by the at least one member.

49. The method according to claim 45, further comprising testing and evaluating the at least one change request after the implementing.
